(19) United States
(12) Patent Application Publication
(10) Pub. No.: US 2015/0286792 A1
(43) Pub. Date: Oct. 8, 2015

(54) SYSTEMS AND METHODS FOR HEALTH RISK DETERMINATION

(71) Applicant: HCMS Group LLC, Cheyenne, WY (US)

(72) Inventors: Harold H. Gardner, Cheyenne, WY (US); Amy N. Atkinson, Windsor, CO (US); Nathan L. Kleinman, Paso Robles, CA (US); Nicholas J. Rohrbacker, Ft. Collins, CO (US); Justin L. Schaneman, Cheyenne, WY (US); Michel R. Simon, Owings Mills, MD (US)

(73) Assignee: HCMS Group LLC, Cheyenne, WY (US)

(21) Appl. No.: 14/262,575

(22) Filed: Apr. 25, 2014

Related U.S. Application Data
(60) Provisional application No. 61/974,948, filed on Apr. 3, 2014.

(51) Int. Cl. G06F 19/00

(52) U.S. Cl. CPC G06F 19/3431; G06Q 40/08

(57) ABSTRACT

Embodiments of the present disclosure help provide an accurate and easily-interpreted measure of health risk based on medical claims, pharmaceutical claims, and lost time claims. Embodiments of the present disclosure also allow for the efficient and accurate comparison of the health risks between different groups of individuals.

### CROSS-REFERENCE TO RELATED APPLICATION

The present application claims priority to Prov. U.S. Pat. App. Ser. No. 61/974,948, filed on Apr. 3, 2014, titled “SYSTEMS AND METHODS FOR HEALTH RISK DETERMINATION,” the entire disclosure of which is incorporated herein by reference.

### BACKGROUND

Health care costs are of significant concern to insurers, health care providers, employers, and other entities. In an attempt to better quantify and predict healthcare costs, some systems attempt to measure a person's health risk using a health risk score. Many such systems, however, calculate such scores based on a single diagnosis and/or fail to consider multiple sources of healthcare costs in calculating the score. Such scores are thus often inaccurate, and reliance on them can lead to waste and inefficiency in addressing healthcare costs. Embodiments of the present disclosure address these and other issues.

### SUMMARY

Embodiments of the present disclosure help provide an accurate and easily-interpreted measure of health risk based on medical claims, pharmaceutical claims, and lost time claims. Embodiments of the present disclosure also allow for the efficient and accurate comparison of the health risks between different groups of individuals.

A computer-implemented method according to various aspects of the present disclosure includes: retrieving, by a computer system, claims data for a plurality of individuals from a database, the claims data including medical claims, pharmacy claims, and lost time claims; determining, by the computer system, an average cost per individual for the medical claims, an average cost per individual for the pharmacy claims, and an average cost per individual for the lost time claims; determining, by the computer system, a percentage contribution to total claim costs from the medical claims, a percentage contribution to total claim costs from the pharmacy claims, and a percentage contribution to total claim costs from the lost time claims; determining, by the computer system for a future time period, a predicted increase in costs associated with the medical claims, a predicted increase in costs associated with the pharmacy claims, and a predicted increase in costs associated with the lost time claims; and determining, by the computer system, a respective weight for each of a plurality of categories within the medical claims based on the average cost per individual for the medical claims, the percentage contribution to total claim costs from the medical claims, and the predicted increase in costs associated with the medical claims; determining, by the computer system, a respective weight for each of a plurality of categories within the pharmacy claims based on the average cost per individual for the pharmacy claims, the percentage contribution to total claim costs from the pharmacy claims, and the predicted increase in costs associated with the pharmacy claims; and determining, by the computer system, a respective weight for each of a plurality of categories within the lost time claims based on the average cost per individual for the lost time claims, the percentage contribution to total claim costs from the lost time claims, and the predicted increase in costs associated with the lost time claims.

The present disclosure includes various methods, apparatuses (including computer systems) that perform such methods, and computer readable media containing instructions that, when executed by computing systems, cause the computing systems to perform such methods.

Other features will be apparent from the accompanying drawings and from the detailed description which follows.

### BRIEF DESCRIPTION OF DRAWINGS

FIG. 1 is a flow diagram of an exemplary method according to various aspects of the present disclosure.

FIG. 2 illustrates exemplary health risk scores according to various aspects of the present disclosure.

FIGS. 3, 4, 5A, 5B, 5C, 5D, 5E, and 5F are exemplary reports according to various aspects of the present disclosure.

FIG. 6 is a block diagram of an exemplary system according to various aspects of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any combination and/or subset of the elements of the methods depicted herein may be combined with each other, selectively performed or not performed based on various conditions, repeated any desired number of times, and practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

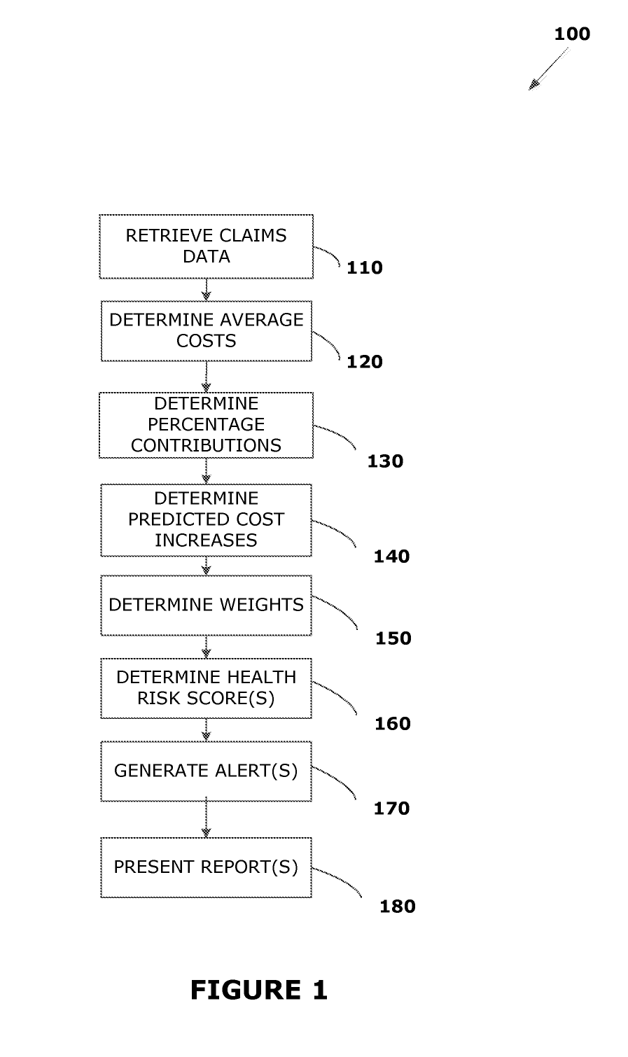

FIG. 1 illustrates an exemplary method according to various aspects of the present disclosure. Method 100 includes retrieving data for one or more claims (110), determining the average cost associated with the claims (120), determining the percentage different types of claims contribute to the total costs of the claims (130), determining predicted increases in costs for different types of claims (140), determining weights for different types of claims (150), determining health risk scores (160), generating one or more alerts based on the health risk scores (170), and presenting one or more reports (180).

Claims data may be retrieved (110) from a variety of sources, such as one or more databases in communication with a computer system performing some or all of the functionality of method 100. Embodiments of the present disclosure may retrieve data for any desired type of claim. In one exemplary embodiment, claims data may include medical claims, pharmacy claims, and/or lost time claims.

Any of the claims data may be grouped into different categories. For example, medical claims may be categorized based on one or more medical diagnostic categories as defined by the United States Agency for Healthcare Research and Quality's (AHRQ), or based on another categorization format. Likewise, pharmacy claims may be categorized based on industry-defined drug classes associated with one or more pharmaceuticals, and lost time claims may be categorized base on the type of lost time (e.g., short-term disability claims, long-term disability claims, worker's compensation claims, etc.). The claims data may include claims for any period of time and may be updated and/or changed as claims are processed, new claims are filed, additional individuals are tracked, or for other reasons.

In exemplary method 100, the average cost associated with different types of claims is determined (120). For example, where claims data includes three types of claims (e.g., medical claims, pharmacy claims, and lost time claims), the average cost of each claim type per individual is determined The sum of the three average costs may also be determined to reflect an integrated average healthcare benefit cost for an individual.

In method 100, the percentage contribution to total claim costs from each type of claim is determined (130). For example, the costs associated with different claims may be determined to be 70% due to medical claims, 14% due to pharmacy claims, and 16% due to lost time claims. In some exemplary embodiments, the percentage contribution to total costs for a particular claim type may be determined using a linear regression model that uses an individual for whom there is claims data as the unit of analysis, with the dependent variable being the average cost of the particular claim type (calculated in step 120). The independent variables to this linear regression analysis may be the claim-specific weight associated with the particular claim type (described with reference to step 150 below). Among other things, the use of regression modeling in determining the contributions of each claim type help maximize the predictive value of the claim type when predicting future costs.

The predicted increase in costs for each claim type may be determined (140) for a future time period. In some exemplary embodiments, as with the determination of the percentage contribution to total costs for a particular claim type, the predicted increase in costs associated with a particular claim type may be determined using a linear regression model that uses an individual for whom there is claims data as the unit of analysis. In such cases, the dependent variable to the linear regression analysis may be the cost from a particular claim type (e.g., medical claims) over a given period of time (e.g., one year), and the independent variables to the linear regression analysis may be categories associated with the particular claim type (e.g., “lung cancer,” “asthma,” “diabetes,” etc. for medical claims) that are dichotomous (i.e., measuring the presence or absence of each category for the individual). The results of the regression model can then yield a value (e.g., in dollars or another currency) for each category representing the predicted increase in costs for that category.

Method 100 further includes the determination of weights for each category within each type of claim (150). In some exemplary embodiments, a category weight may be determined as the quotient of the predicted increase in costs for the category (determined in step 140) divided by the average per-individual cost for the claim type (determined in step 120). A category weight may also be determined as the quotient of the predicted increase in costs for the category divided by the product of the average per-individual cost for the claim type and the percentage contribution to total claim costs from the claim type (determined in step 130). This latter manner for determining category weights thus takes into consideration the cost impact of each claim type in relation to other types of claims.

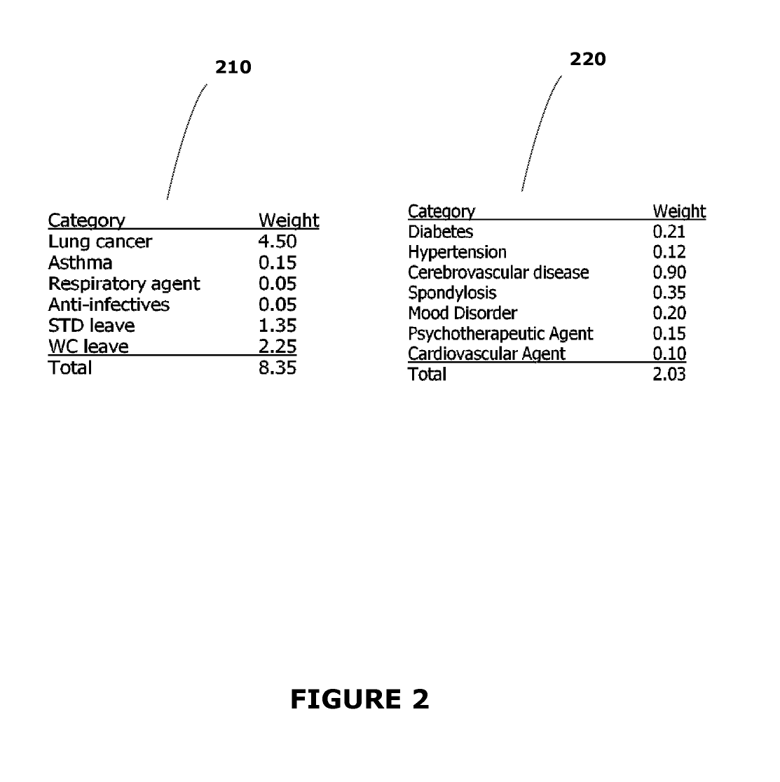

A health risk score may be determined (160) for one or more individuals. In some embodiments, the health risk score is the sum of category weights from different claim types that are applicable to the individual. For example, referring now to FIG. 2, health risk scores for two different individuals (210, 220) is shown. The left table is for an exemplary individual 210 having two medical claim categories (lung cancer and asthma), two pharmacy claim categories (respiratory agent and anti-infectives), and two lost time claim categories (short-term disability leave and worker's compensation leave). The sum of weights of each category for individual 210 amounts to 8.35.

The right table shows an exemplary individual 220 having six medical claim categories (diabetes through mood disorder), two pharmacy claim categories (psychotherapeutic agent and cardiovascular agent) and no lost time claim categories. The sum of the weights for each category for individual 220 is 2.03. Health risk scores may be determined on claim categories occurring during any desired period of time (e.g., one year), and claim categories may be added or removed from consideration in a health risk score.

In the example depicted in FIG. 2, the health risk scores shown are based on a 1.0 normalized scale. In other words, a health risk score less than 1.0 indicates the individual has a lower than average health risk. A health risk score greater than 1.0 indicates the individual has a higher than average health risk. The health risk score in this example is also scaled such that the health risk of individual 210 indicates he/she has 8.35 times the health risk of an average individual, while individual 220 has 2.03 times the health risk of an average individual. By contrast, a health score of 0.5 would indicate half the health risk of an average individual.

The health risk score may be determined for any desired group of individuals, so the health risk score of an “average individual” may change based on the population being sampled, and the health risk scores and other characteristics of different groups compared. For example, health risk scores may be determined for every individual having claims data in a database, or select groups of individuals. For example, a first group of individuals that are employees from a company may be grouped together and their health risk scores compared to a second group of individuals that includes dependents of the employees in the first group. Different groups of employees within a company (e.g., from different departments) may also be compared.

Embodiments of the present disclosure may generate one or more alerts (170) in response to a variety of conditions. For example, a history of health risk scores for different individuals can be stored and monitored. As existing claims are processed and/or new claims are filed, healthcare providers and other users of the embodiments of the present disclosure can be automatically alerted in response to changes in an individual's health risk score or the components thereof. In one exemplary embodiment, updated claims data is retrieved and used to re-determine the health risk scores for individuals having updated claims data. In response to the health risk score for an individual changing (increasing or decreasing) by a predetermined amount and/or exceeding a predetermined threshold. The alert can be provided in any desired manner, such as in an electronic communication (e.g., an email, voicemail, SMS text, etc.) or via a user interface (e.g., display screen) in communication with a computer system implementing methods of the present disclosure. The alert can contain any desired information, such as an individual's health risk score and/or any claims data used in determining the score.

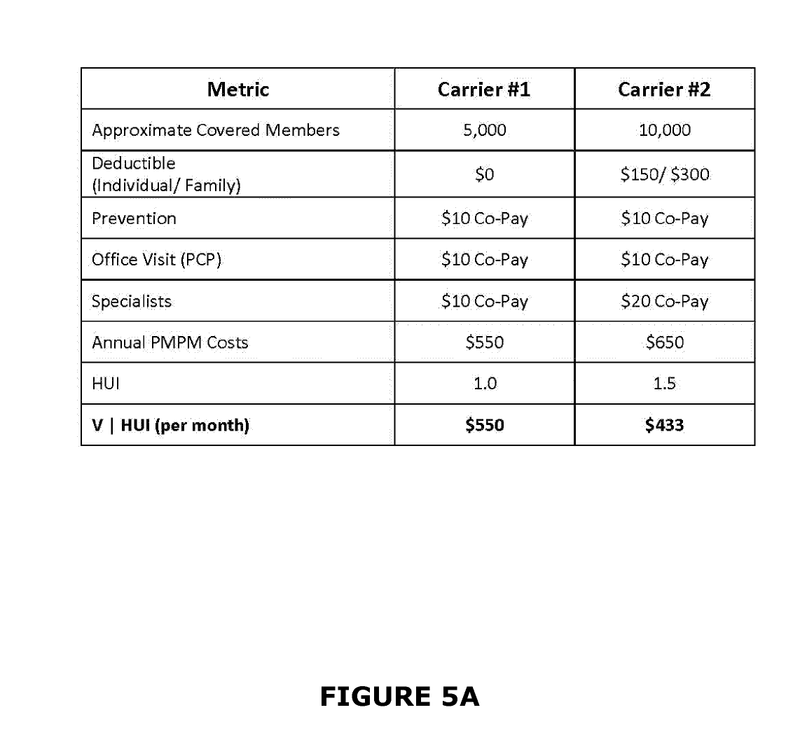

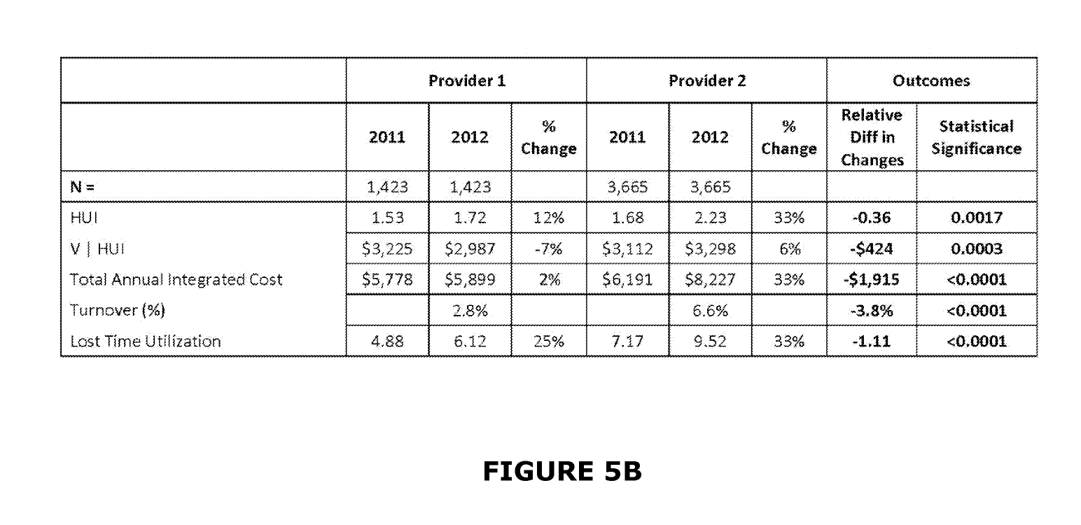

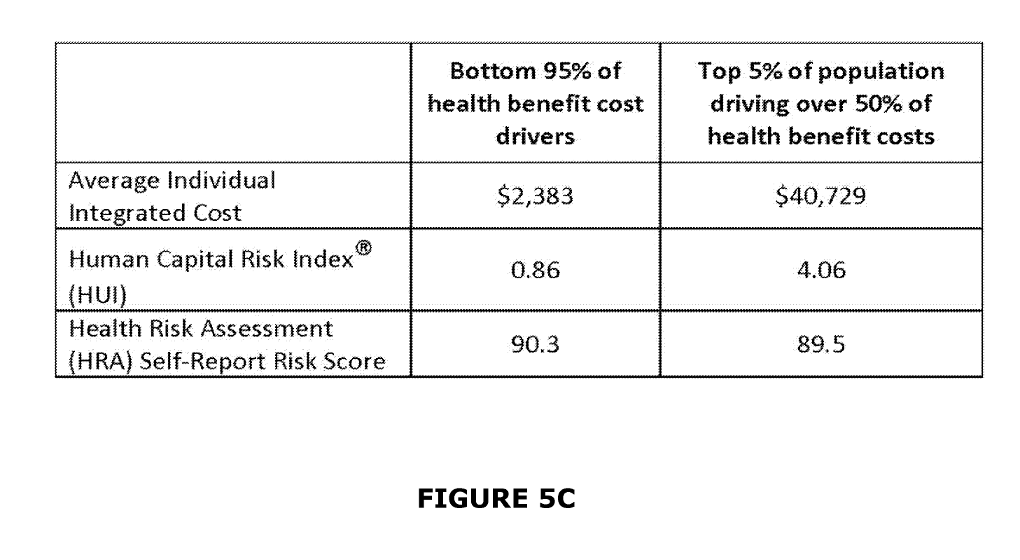

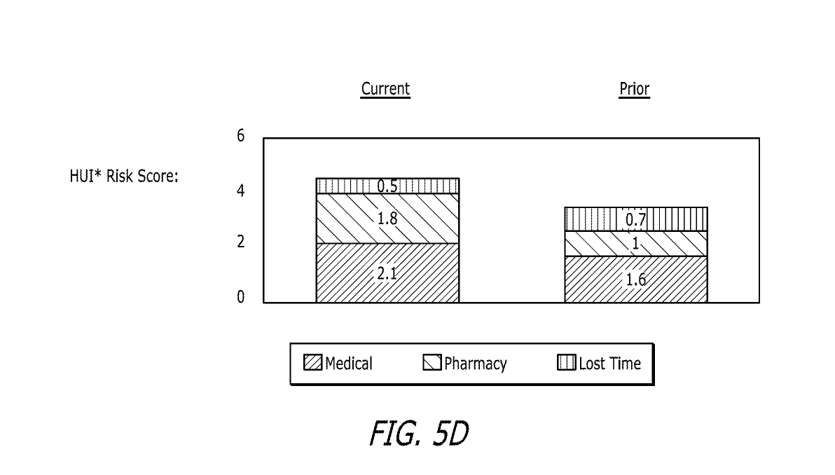

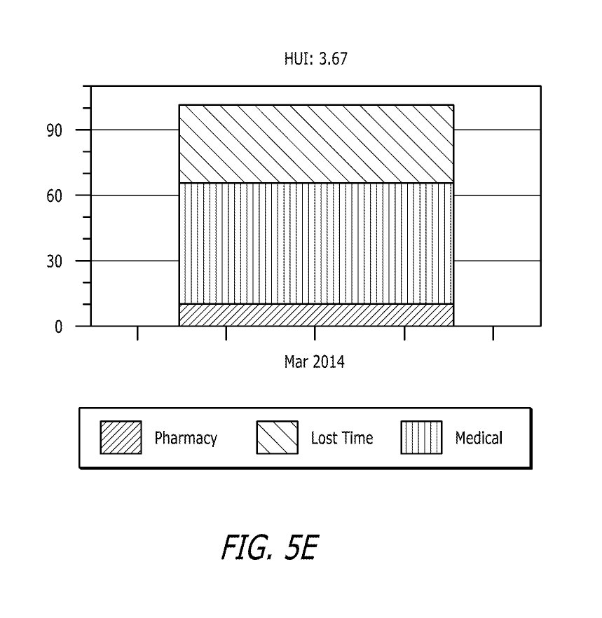

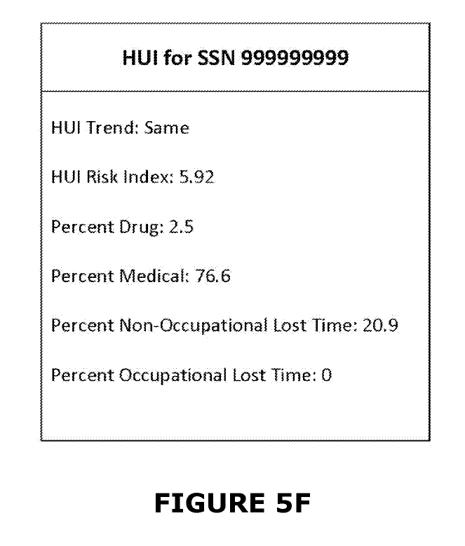

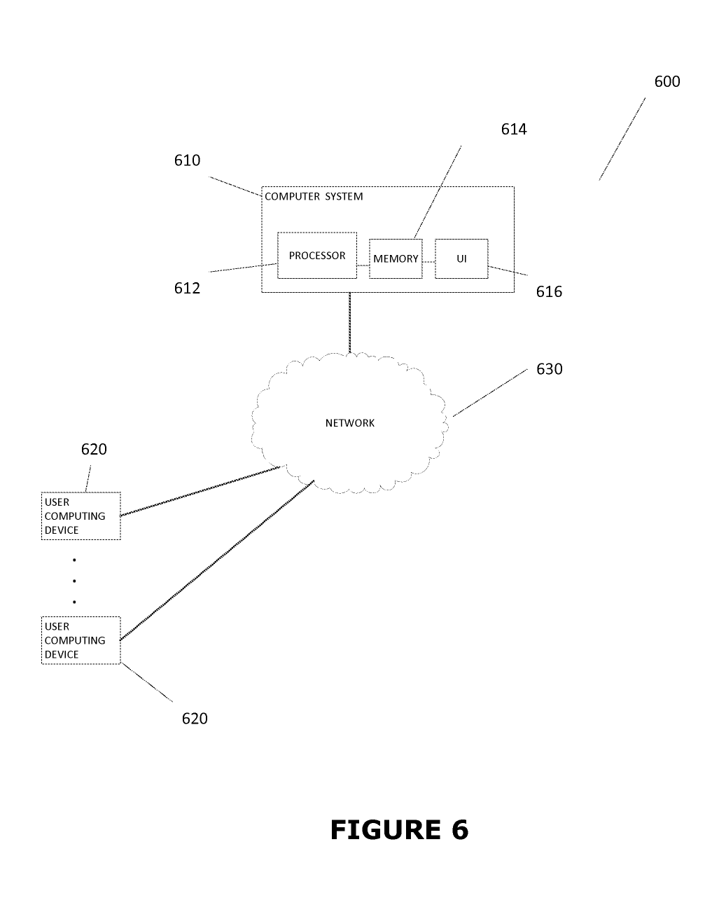

In other exemplary embodiments, re-determined health risk scores may be presented in any of the same or different manners described herein, such as is shown in FIGS. 5A-6. For example, the re-determined health risk scores for one or more individuals having updated claims data may be presented along with a historical trend of previously-determined health risk scores for the individual(s) having updated claims data and the respective medical claim category weights, pharmacy claim category weights, and lost time category weights that are attributable to each respective individual having updated claims data.

Embodiments of the present disclosure may also generate and present different reports (180) to users. Reports may be presented in any desired manner, such as via electronic communication and/or user interface in the same manner as alerts described above. Reports may be presented with a variety of information, including individual health risk scores and/or health risk scores for different groups. In one exemplary embodiment, a graphical comparison of health risk scores and/or healthcare costs for each individual in a group may be presented, such as via graph or chart. Health risk scores may be presented in any desired manner, such as graphically and/or textually.

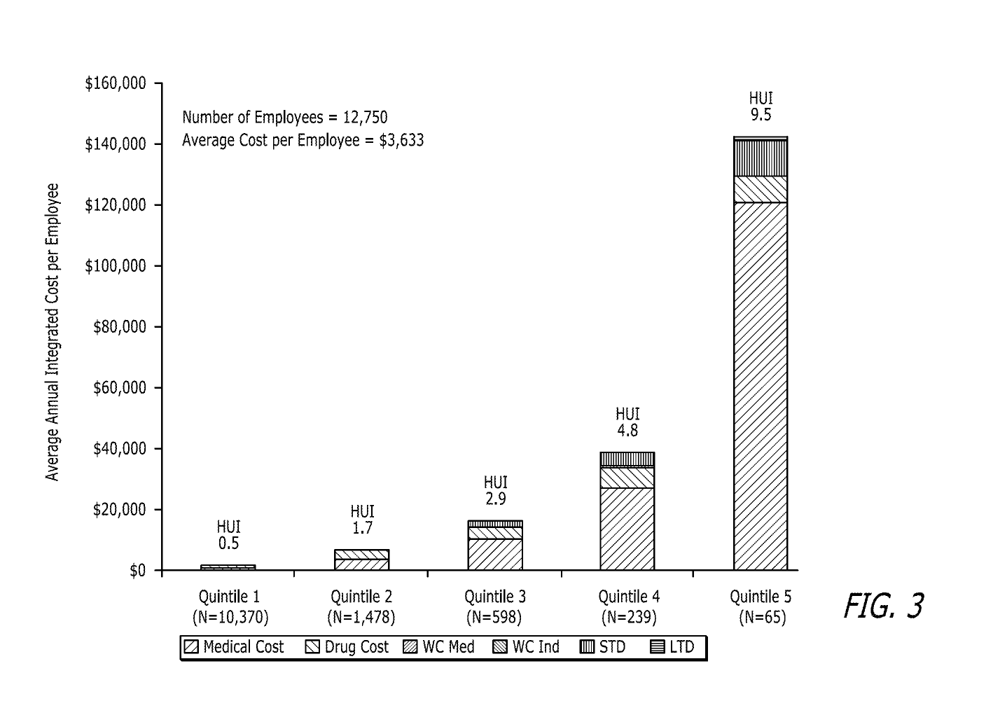

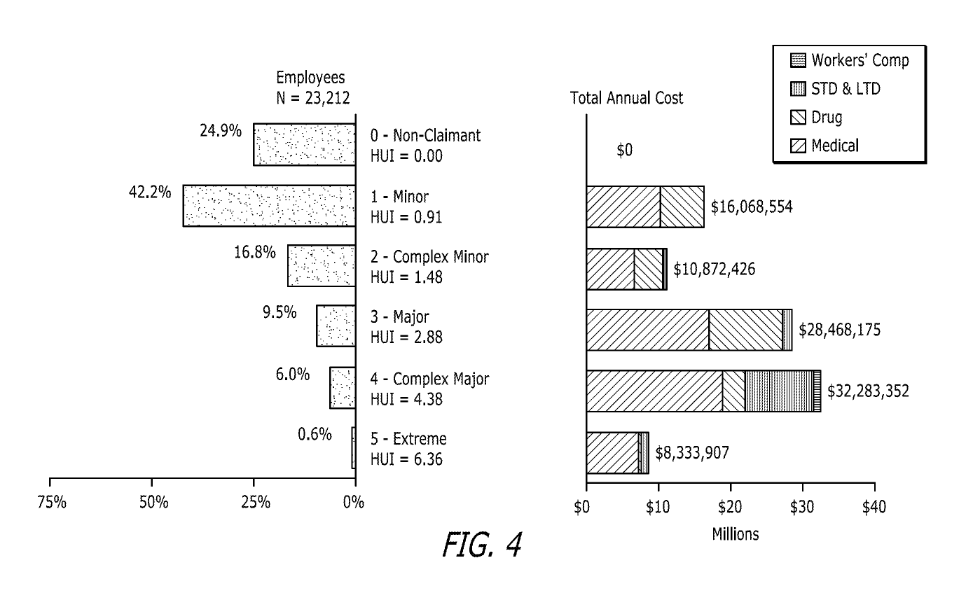

FIGS. 3 and 4 illustrate exemplary graphical presentations showing the health risk scores and health care costs for a group of individuals. In FIG. 3, health risk scores and associated costs for a group of 12,750 employees are broken into five groups (quintiles). Each quintile shows the proportion of healthcare costs attributable to medical claims, pharmaceutical (drug) claims, and four types of lost time claims: worker's compensation medical claims or “WC Med,” worker's compensation indemnity claims or “WC Ind,” short term disability or “STD,” and long term disability or “LTD.” In this example, the health risk score (labeled “HUI”) for the majority of the employees averages 0.5 on a 1.0 scale, thus the health risk for most employees is half the average risk. The health risk scores for the remaining four quintiles are 1.7, 2.9, 4.8, and 9.5, respectively. The 65 employees in the fifth quintile, therefore, have 9.5 times more health risk than average, and the average annual healthcare benefit cost associated with each employee is far greater than for the employees in the other quartiles. In this manner, embodiments of the present disclosure can apprise employers, insurers, healthcare providers, and/or other users with information to help them identify trends in health risk scores over time, as well as to provide targeted assistance to individuals, particularly those with increasing health risk scores.

FIG. 4 depicts another example of graphically presenting the health risk scores (again labeled “HUI”) for a group of employees along with associated health care costs. As in FIG. 3, the proportional cost associated with various claim types for each group are shown. In other exemplary embodiments, health scores for two or more groups of individuals may be determined (as in step 160 described above) and then a graphical comparison of the health scores for the different groups presented.

In other embodiments, reports may be presented to provide a graphical and/or textual comparison of metrics for different health coverage plans, providers, and/or health programs to help provide a risk-adjusted comparison to determine which is most effective at managing risk. Embodiments of the present disclosure may provide comparisons of any other desired data. For example, referring now to FIG. 5A, metrics for two healthcare plans (provided by Carrier #1 and Carrier #2) are shown side-by-side. The metrics include the per member per month (PMPM) cost associated with each plan, as well as an indicator (in the second-to-last row) showing the average health risk score of the population served by the respective plans. In the last row, the metrics include an indicator of the cost of the health plan per unit of a health risk score. As with the previous examples, the health risk score (labeled HUI) is based on a normalized 1.0 scale (i.e., 1.0 indicates average risk), and the “V|HUI” thus shows the cost per unit risk under each plan, or the cost to cover an individual having an average health risk of 1.0.

FIG. 5B illustrates an exemplary comparison report that provides a comparison of metrics for two healthcare providers. As with FIG. 5A, the average health risk score (“HUI”) of the populations served by Provider 1 and Provider 2 are shown along with cost per unit risk (“V|HUI”) for each provider for 2011 and 2012.

FIG. 5C is an exemplary report comparing health risk scores determined in accordance with embodiments of the present disclosure (HUI) with a conventional health score (HRA) associated with another scoring index. This Figure illustrates a benefit identified by the inventors of this Application, namely that the health risk scores determined in accordance with the systems and methods described herein are much better predictive tools than other conventional scores. In FIG. 5C, for example, the average HUI for the bottom 95% of a population (with regards to health benefit costs) is 0.86 on a normalized 1.0 scale, while the top 5% has an average HUI of 4.06. This indicates that the members of the top 5% have over four times the health risk than the members of the bottom 95%, which is supported by the stark difference in individual costs ($2,383 vs. $40,729) for the two groups. The HRA score, by contrast, is actually lower for the top 5% (89.5) than for the bottom 95% (90.3), thus showing little or no correlation to the health care costs of the respective groups. The HRA score is therefore far less valuable as a predictor of health benefit costs than the HUI score determined in accordance with the embodiments of the present application.

FIGS. 5D-5F depict examples of reports presenting the health risk score (again labeled “HUI”) for an individual via a user interface in communication with a computer system providing the HUI. In some exemplary embodiments, the user interface may be part of a health care provider's system at the point of care, and the HUI score is presented from within the provider's electronic medical record system. The HUI score may be presented to any other desired user, system, device, or combinations thereof. The HUI score may be presented in any suitable manner, such as graphically, textually, or combinations thereof.

In each of FIGS. 5D-5F, the proportional contribution to the health risk score associated with the medical, drug, and lost time claim types is shown. In some exemplary embodiments, the health risk score for a previous time period may be compared with the health risk score for the current time period. In FIG. 5D, for example, the current health risk score for an individual is presented along with a previously-determined health risk score for the individual. The medical claim category weights, pharmacy claim category weights, and lost time category weights attributable to the individual for each score are also shown. In this example, the individual's overall health risk score has increased from his/her previously-determined score (4.4 vs. 2.4), which includes an increase from 1.6 to 2.1 due to medical claims, an increase from 1.0 to 1.8 for pharmacy claims, and a decrease from 0.7 to 0.5 for lost time claims. Current and prior health risk scores, as well as the category weights influencing such scores, may be presented for any number of individuals and/or groups of individuals.

FIG. 5E depicts another example of the presentation of a health risk score where the relative percentage contribution to the health risk score for each of medical claims, pharmacy claims, and lost time claims, is shown graphically. Similarly, FIG. 5F shows a textual presentation of a health risk score for an individual with the percentage contributions to the health risk score from medical claims 76.6 percent), pharmacy claims 2.5 percent), and lost time claims 20.9 percent).

Among other things, alerts (170) and reports (180) generated and presented by embodiments of the present disclosure help users identify trends and even targeted intervention by healthcare providers to address, for example, individuals with particularly high health risk scores. Reports may also look at historical data in retrospect or provide predictive analyses for future time periods.

FIG. 6 is a block diagram of system which may be used in conjunction with various embodiments. While FIG. 6 illustrates various components of a computer system, it is not intended to represent any particular architecture or manner of interconnecting the components. Other systems that have fewer or more components may also be used.

In FIG. 6, the system 600 includes a computer system 610 comprising a processor 612, memory 614, and user interface 616. Computer system 610 may include any number of different processors, memory components, and user interface components, and may interact with any other desired systems and devices in conjunction with embodiments of the present disclosure.

The functionality of the computer system 610, including the steps of the methods described above (in whole or in part), may be implemented through the processor 612 executing computer-readable instructions stored in the memory 614 of the system 610. The memory 614 may store any computer-readable instructions and data, including software applications, applets, and embedded operating code. Portions of the functionality of the methods described herein may also be performed via software operating on one or more of the user computing devices 620.

The functionality of the system 610 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 612 retrieves and executes instructions stored in the memory 614 to control the operation of the system 610. Any type of processor, such as an integrated circuit microprocessor, microcontroller, and/or digital signal processor (DSP), can be used in conjunction with embodiments of the present disclosure. A memory 614 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 614 in any desired manner, such as in a relational database.

The system 610 includes a user interface 616 that may include any number of input devices (not shown) to receive commands, data, and other suitable input. The user interface 616 may also include any number of output devices (not shown) to provides the user with data, notifications, and other information. Typical I/O devices may include mice, keyboards, modems, network interfaces, printers, scanners, video cameras and other devices.

The system 610 may communicate with one or more user computing devices 620, as well as other systems and devices in any desired manner, including via network 630. The system 610 and/or user computing devices 620 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device.

The network 630 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

Communication among systems, devices, and components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: shipping data, package data, and/or any data useful in the operation of the system.

Various functionality may be performed via a web browser and/or application interfacing utilizing a web browser. Such browser applications may comprise Internet browsing software installed within a computing unit or a system to perform various functions. These computing units or systems may take the form of a computer or set of computers, and any type of computing device or systems may be used, including laptops, notebooks, tablets, hand held computers, personal digital assistants, set-top boxes, workstations, computer-servers, main frame computers, mini-computers, PC servers, network sets of computers, personal computers and tablet computers, such as iPads, iMACs, and MacBooks, kiosks, terminals, point of sale (POS) devices and/or terminals, televisions, or any other device capable of receiving data over a network. Various embodiments may utilize Microsoft Internet Explorer, Mozilla Firefox, Google Chrome, Apple Safari, Opera, or any other of the myriad software packages available for browsing the internet.

Various embodiments may operate in conjunction with any suitable operating system (e.g., Windows NT, 95/98/2000/CE/Mobile/, Windows 7/8, OS2, UNIX, Linux, Solaris, MacOS, PalmOS, etc.) as well as various conventional support software and drivers typically associated with computers. Various embodiments may include any suitable personal computer, network computer, workstation, personal digital assistant, cellular phone, smart phone, minicomputer, mainframe or the like. Embodiments may implement security protocols, such as Secure Sockets Layer (SSL), Transport Layer Security (TLS), and Secure Shell (SSH). Embodiments may implement any desired application layer protocol, including http, https, ftp, and sftp.

The various system components may be independently, separately or collectively suitably coupled to a network via data links which includes, for example, a connection to an Internet Service Provider (ISP) over the local loop as is typically used in connection with standard modem communication, cable modem, satellite networks, ISDN, Digital Subscriber Line (DSL), or various wireless communication methods. It is noted that embodiments of the present disclosure may operate in conjunction with any suitable type of network, such as an interactive television (ITV) network.

The system may be partially or fully implemented using cloud computing. “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Various embodiments may be used in conjunction with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

Any databases, systems, devices, servers or other components of the system may be located at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

Embodiments may connect to the Internet or an intranet using standard dial-up, cable, DSL or any other Internet protocol known in the art. Transactions may pass through a firewall in order to prevent unauthorized access from users of other networks.

The computers discussed herein may provide a suitable website or other Internet-based graphical user interface which is accessible by users. For example, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In another example, an Apache web server can be used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet.

Various embodiments may employ any desired number of methods for displaying data within a browser-based document. For example, data may be represented as standard text or within a fixed list, scrollable list, drop-down list, editable text field, fixed text field, pop-up window, and the like. Likewise, embodiments may utilize any desired number of methods for modifying data in a web page such as, for example, free text entry using a keyboard, selection of menu items, check boxes, option boxes, and the like.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A computer-implemented method comprising:
retrieving, by a computer system, claims data for a plurality of individuals from a database, the claims data including medical claims, pharmacy claims, and lost time claims;
determining, by the computer system, an average cost per individual for the medical claims, an average cost per individual for the pharmacy claims, and an average cost per individual for the lost time claims;
determining, by the computer system, a percentage contribution to total claim costs from the medical claims, a percentage contribution to total claim costs from the pharmacy claims, and a percentage contribution to total claim costs from the lost time claims;
determining, by the computer system for a future time period, a predicted increase in costs associated with the medical claims, a predicted increase in costs associated with the pharmacy claims, and a predicted increase in costs associated with the lost time claims;
determining, by the computer system, a respective weight for each of a plurality of categories within the medical claims based on the average cost per individual for the medical claims, the percentage contribution to total claim costs from the medical claims, and the predicted increase in costs associated with the medical claims;
determining, by the computer system, a respective weight for each of a plurality of categories within the pharmacy claims based on the average cost per individual for the pharmacy claims, the percentage contribution to total claim costs from the pharmacy claims, and the predicted increase in costs associated with the pharmacy claims; and
determining, by the computer system, a respective weight for each of a plurality of categories within the lost time claims based on the average cost per individual for the lost time claims, the percentage contribution to total claim costs from the lost time claims, and the predicted increase in costs associated with the lost time claims.

2. The method of claim 1, wherein the plurality of categories within the medical claims include a category associated with one or more medical diagnoses.

3. The method of claim 1, wherein the plurality of categories within the pharmacy claims include a category associated with one or more pharmaceuticals.

4. The method of claim 1, wherein the plurality of categories within the lost time claims include a category associated with one or more of: disability claims and worker's compensation claims.

5. The method of claim 1, further comprising determining a health risk score for an individual from the plurality of individuals, wherein the health risk score includes a sum of the medical claim category weights, the pharmacy claim category weights, and the lost time category weights that are attributable to the individual.

6. The method of claim 5, further comprising presenting, via a user interface in communication with the computer system:
the health risk score for the individual from the plurality of individuals;
a historical trend of previously-determined health risk scores for the individual; and
the medical claim category weights, the pharmacy claim category weights, and the lost time category weights that are attributable to the individual.

7. The method of claim 1, further comprising determining a respective health risk score for each individual in a group of individuals from the plurality of individuals, wherein the health risk score for each respective individual includes a sum of the medical claim category weights, the pharmacy claim category weights, and the lost time category weights that are attributable to the respective individual.

8. The method of claim 7, further comprising presenting, via a user interface in communication with the computer system, a graphical comparison of the health risk scores for the individuals in the group of individuals.

9. The method of claim 7, further comprising presenting, via a user interface in communication with the computer system, a graphical comparison of healthcare costs for the individuals in the group of individuals.

10. The method of claim 7, further comprising presenting, via a user interface in communication with the computer system, a graphical comparison of metrics for a first health coverage plan and a second health coverage plan, wherein the metrics include an indicator of a cost to cover a unit of the health risk scores under first plan and an indicator of a cost to cover a unit of the health risk scores under the second plan.

11. The method of claim 7, further comprising presenting, via a user interface in communication with the computer system, a graphical comparison of metrics for a first health care provider and a second health care provider, wherein the metrics include an indicator of a cost to cover a unit of the health risk scores under first plan and an indicator of a cost to cover a unit of the health risk scores under the second plan.

12. The method of claim 7, further comprising presenting, via a user interface in communication with the computer system, a graphical comparison of the health risk scores determined for the group of individuals and a health score associated with another scoring index for the group.

13. The method of claim 7, wherein the health risk scores are normalized to a base value such that a health risk score over the base value indicates a higher than average risk, and a health risk score lower than the base value indicates a lower than average risk.

14. The method of claim 7, further comprising:
retrieving updated claims data from the database during the future time period;
re-determining health risk scores for individuals having updated claims data; and
generating an alert, via a user interface in communication with the computer system, in response to a re-determined health risk score for an individual changing by at least a predetermined amount.

15. The method of claim 14, further comprising presenting, via a user interface in communication with the computer system:
the re-determined health risk scores for the individuals having updated claims data;
a historical trend of previously-determined health risk scores for the individuals having updated claims data; and
the respective medical claim category weights, pharmacy claim category weights, and lost time category weights that are attributable to each respective individual having updated claims data.

16. The method of claim 1, further comprising:
determining a respective health risk score each individual in a first group of individuals from the plurality of individuals and a second group of individuals from the plurality of individuals, wherein the health risk score for each respective individual includes a sum of the medical claim category weights, the pharmacy claim category weights, and the lost time category weights that are attributable to the respective individual; and
presenting, via a user interface in communication with the computer system, a graphical comparison of the health risk scores for the first group and the health risk scores for the second group.

17. The method of claim 16, wherein the first group of individuals includes employees of a company and the second group of individuals includes dependents of the employees in the first group.

18. The method of claim 16, wherein the first group of individuals includes employees in a first department of a company and the second group of individuals includes employees in a second department of the company.

19. The method of claim 1, wherein determining the predicted increase in costs associated with the medical claims, the predicted increase in costs associated with the pharmacy claims, and the predicted increase in costs associated with the lost time claims includes performing a linear regression analysis on the claims data for each individual from the plurality of individuals.

20. The method of claim 1, wherein determining the percentage contribution to total claim costs from the medical claims, the percentage contribution to total claim costs from the pharmacy claims, and the percentage contribution to total claim costs from the lost time claims includes performing a linear regression analysis on the claims data for each individual from the plurality of individuals.

21. The method of claim 1, wherein the respective weight for each of the plurality of categories within the medical claims is the quotient of the predicted increase in costs associated with the respective medical claim category divided by the product of the average cost per individual for the respective medical claim category and the percentage contribution to total claim costs from the respective medical claim category.

22. The method of claim 1, wherein the respective weight for each of the plurality of categories within the pharmaceutical claims is the quotient of the predicted increase in costs associated with the respective pharmaceutical claim category divided by the product of the average cost per individual for the respective pharmaceutical claim category and the percentage contribution to total claim costs from the respective pharmaceutical claim category.

23. The method of claim 1, wherein the respective weight for each of the plurality of categories within the lost time claims is the quotient of the predicted increase in costs associated with the respective lost time claim category divided by the product of the average cost per individual for the respective lost time claim category and the percentage contribution to total claim costs from the respective lost time claim category.

24. A non-transitory, computer-readable medium storing instructions that, when executed, cause a computer system to:
retrieve claims data for a plurality of individuals from a database, the claims data including medical claims, pharmacy claims, and lost time claims;
determine an average cost per individual for the medical claims, an average cost per individual for the pharmacy claims, and an average cost per individual for the lost time claims;
determine a percentage contribution to total claim costs from the medical claims, a percentage contribution to total claim costs from the pharmacy claims, and a percentage contribution to total claim costs from the lost time claims;
determine, for a future time period, a predicted increase in costs associated with the medical claims, a predicted increase in costs associated with the pharmacy claims, and a predicted increase in costs associated with the lost time claims;
determine a respective weight for each of a plurality of categories within the medical claims based on the average cost per individual for the medical claims, the percentage contribution to total claim costs from the medical claims, and the predicted increase in costs associated with the medical claims;
determine a respective weight for each of a plurality of categories within the pharmacy claims based on the average cost per individual for the pharmacy claims, the percentage contribution to total claim costs from the pharmacy claims, and the predicted increase in costs associated with the pharmacy claims; and
determine a respective weight for each of a plurality of categories within the lost time claims based on the average cost per individual for the lost time claims, the percentage contribution to total claim costs from the lost time claims, and the predicted increase in costs associated with the lost time claims.

25. A system comprising:
a processor; and
memory in communication with the processor and storing instructions that, when executed by the processor, cause the system to:
retrieve claims data for a plurality of individuals from a database, the claims data including medical claims, pharmacy claims, and lost time claims;
determine an average cost per individual for the medical claims, an average cost per individual for the pharmacy claims, and an average cost per individual for the lost time claims;
determine a percentage contribution to total claim costs from the medical claims, a percentage contribution to total claim costs from the pharmacy claims, and a percentage contribution to total claim costs from the lost time claims;
determine, for a future time period, a predicted increase in costs associated with the medical claims, a predicted increase in costs associated with the pharmacy claims, and a predicted increase in costs associated with the lost time claims;
determine a respective weight for each of a plurality of categories within the medical claims based on the average cost per individual for the medical claims, the percentage contribution to total claim costs from the medical claims, and the predicted increase in costs associated with the medical claims;
determine a respective weight for each of a plurality of categories within the pharmacy claims based on the average cost per individual for the pharmacy claims, the percentage contribution to total claim costs from the pharmacy claims, and the predicted increase in costs associated with the pharmacy claims; and
determine a respective weight for each of a plurality of categories within the lost time claims based on the average cost per individual for the lost time claims, the percentage contribution to total claim costs from the lost time claims, and the predicted increase in costs associated with the lost time claims.
